(19) United States
(12) Patent Application Publication
(10) Pub. No.: US 2005/0267812 A1
(43) Pub. Date: Dec. 1, 2005

(54) Method for providing discount offers to a user

(76) Inventors: Scott C. Jensen, Morgan Hill, CA (US); Jeffrey Tablak, San Jose, CA (US)

Correspondence Address: Donald L. Bartels;COUDERT BROTHERS LLP, Two Palo Alto Square, 3000 El Camino Real, Fourth Floor, Palo Alto, CA, 94306, US

(21) Appl. No.: 10/847,778

(22) Filed: May 17, 2004

(51) Int. Cl. G06F 17/60

(52) U.S. Cl. 705/26; 705/14

(57) ABSTRACT

A method for providing a user with merchant discount offers comprising obtaining a profile from the user; storing discount offers received from one or more merchants as data in a merchant database; comparing the profile of the user with the data in the merchant database to identify matches of discounts offered by the merchants that likely may be of interest to the user based on the user profile; creating a personalized shopping guide for the user which lists the matches; displaying the personalized shopping guide to the user; enabling the user to select one or more discount offers of interest from the personalized shopping guide; storing the selected discount offers of interest in a selection database accessible to the user; and enabling a merchant to identify the user and to gain access to the selection database at the point of sale. The merchant is preferably a mall based store. The method also enables a user to setup a “wish list” of selected items which are of interest to the user when a discount offer becomes available, and to notify the user when offers for the selected items become available.

### FIELD OF THE INVENTION

The invention relates generally to a method of providing discount offers, and more specifically, to a method of providing a user with merchant discount offers based on the user's profile and enabling the user to select an offer of interest.

### BACKGROUND OF THE INVENTION

In the last 50 years advertising expenditures have grown from $7 billion to $228 billion, a 3,157% increase, while the U.S. population grew just 89%. According to the Television Bureau of Advertising, on a per capita basis, advertising expenditures has grown from $46 in 1953 to $800 in 2003. In view of the enormous cost of advertising expenditures and their finite resources, corporate advertisers recognize the importance of evaluating the return on investment (ROI) on their advertising expenditures. This factor accounts for the rapid growth of advertising channels which can be more accurately measured, such as direct mail and the Internet, versus those which cannot, such as commercial television. Advertising for which results can be more accurately measured typically commands a higher CPM (cost per thousand impressions) rate than other advertising. There is therefore a need for a method that provides the kind of measurable results sought by advertisers.

The entire set of channels available to deliver advertising messages to parts or all of the public is typically described as media. “Mass media” typically refers to channels, such as broadcast or print, that are used to distribute the same message to many people simultaneously. A channel for delivering messages to one person at a time is considered a carrier rather than a mass media. Another major difference between a media and a carrier is that a carrier can be used to conduct interactive dialog between the parties while mass media provides only one way communication. The telephones and the Internet are examples of a carrier capable of two way interaction.

The growth of shopping related websites and search engines on the Internet has demonstrated that shoppers want quick and easy access to comprehensive product information and pricing. Search engines such as GOOGLE and YAHOO have greatly simplified the consumer's shopping experience on the Internet for many retail categories. Although many shoppers enjoy the convenience of online search and comparison capabilities, only a small percent of them are consummating online transactions in place of transactions at the physical, “brick and mortar”, retail stores, such as at the mall. According to the U.S. Department of Commerce total retail sales in the US were $3.5 trillion in 2002 and 3.4 trillion in 2003. These figures represent approximately 31% of the country's Gross Domestic Product (GDP). The Commerce department also estimates that e-commerce sales in 2003 were $54.9 billion which is equal to 1.6% of the total retail sales. Despite economists predictions that future growth of e-commerce will be in excess of 20%, these transactions will still represent only a fraction of sales volume that brick and mortar retail stores will generate in the coming decade. Even though shoppers enjoy the convenience of online shopping, the large majority of purchases are still made person to person.

A carrier capable of reaching a mass market while providing a high level of interactivity is typically described as being “new media”. Personalized grocery store checkout coupons and electronic information kiosks are examples of new media. The Internet has been promoted as one of the most effective forms of new media but the abundance of unsolicited email is limiting its effectiveness. What is needed is a method that uses the new media in the form of personalized websites to promote targeted marketing for merchants while allowing consumers to only receive and view information about products and services that the consumers have specifically requested. Some consumers may wish to only view offers from a specific merchant while others may want to see all offers in a specific category. While some consumers may desire to view the nformation in a personalized website via the web at home or while at the mall, others may wish to view the data via their email, cell phone, or other wireless devices.

Advertisers are no longer content to limit their commercial messages to channels of communications directed toward the home. As a result, advertisers are seeking out-of-home venues where large numbers of people congregate such as music concerts, sporting events, and major thoroughfares. One example of a major venue which attracts millions of people per month is a large “super-regional” shopping mall. According to the International Council of Shopping Centers, in 2002 there were 746 larger shopping malls each having over 800,000 square feet which kept the average visitor 76 minutes per visit. These large malls typically are super-regional malls that attract visitors from the immediate and surrounding regions. Consumer spending is the single largest segment of our gross domestic product (GDP). Shopping malls provide a prime venue for consumer spending dollars and thus play a dominate role in the nation's economy. There is a need, therefore, for a method that provides the measurable results that advertisers seek that is especially effective in large super-regional shopping malls.

Advertising has been characterized by a rule referred to as the “3000/80/10” rule. According to this rule, an average consumer is exposed to 3,000 advertising messages each day, of which 80 are noticed, and only 10 get a reaction. With the effectiveness of mass media advertising, such as television commercials, on the decline, merchants and manufacturers are looking for more cost effective ways to communicate relevant information to their current and potential customers.

Electronic mail (“email”) is an example of an interactive carrier. Much of the email currently received by home users is unsolicited email, commonly referred to as “spam”. Spam is regarded as a nuisance by the recipients because it requires them to take time to identify the message as spam, may contain adult oriented lewd messages, and can occupy storage space needed for the necessary computer functions. The San Jose Mercury News reported that in January 2004 an estimated 139 trillion spam messages were sent on the internet. This unsolicited email “spam” is not much different than receiving an annoying telemarketing phone call at dinner time. As a result, advertising through email has been abused to the point that it is losing effectiveness. What is needed is a method that eliminates the negative issues associated with email marketing and provides a much more robust format for presenting shopping opportunities.

The use of profiling is needed such that users will only receive merchant offers about which they have indicated an interest, i.e., opted-in. Known methods automatically create profiles based on users previous buying history and patterns without the user being aware or having chosen to allow the creation of a profile. The drawback of such methods is that it can bring about unsolicited spam email which users abhor. What is needed therefore is a method for using profiles that enables a user to have some control of the profile such as the ability to edit and change their profile at any time.

Potential customers are typically attracted to discount offers and therefore, are more likely to be receptive to such offers provided by a merchant. Customers have understandably grown leery, however, of unsolicited marketing based emails. A drawback of known methods is that the methods are not directed toward discount offers or focus on the delivery of discount coupons without providing a personalized shopping guide of items of interest based on a user profile. What is needed is a method that delivers appropriate sales and discount offers via the World Wide Web or other suitable network without relying on email as the sole means of delivery of the offer. The needed method should enable a user to view any marketing messages in the user's own time frame, e.g., before going on a shopping trip or after they arrive at the retail outlet in a mall. For the needed method, users should have the opportunity to have discount offers delivered via other media such as email or text messaging, but only when the user opts-in such that the user is given control as to how, when, and where the user is to receive the discount offers.

There is a need, therefore, for a method to provide more cost effective advertising for merchants, manufacturers, and mall ownership companies, in order to reduce reliance on low percentage response and low ROI advertising methods such as telemarketing, direct mail and spam email. There is also a need for a permission based interactive information exchange between merchants and shoppers. There is also a need to provide membership services to shoppers to promote repeat customers to simplify the shopping experience for the customer. What is also needed is a method that provides shopping discounts to users who become members wherein the membership shopping discounts are not available to the general public.

The use of “special sales” and “price-off” merchandising at the retail level has become so prolific that consumers often are reluctant to purchase anything at the full retail price. Although merchants typically have discount offers which are available to consumers, present methods of communicating these offers to consumers is generally wasteful and ineffective. The use of convenient search engines available when shopping online is in contrast to the normal shopping excursion experience at a large retail super mall. A typical super-regional shopping mall has about 150 retailers. Most of these retailers offering discounts and special sales prices at any given time. A shopping mall patron has a difficult task in determining which discount offers are available in the mall and if discovered, matching these offers to their personal interests. At present, in order to get this information, a consumer must resort to manually searching advertisements in the local newspaper, etc.; diligently reading every piece of direct mail; or physically visiting each of the stores in the mall.

What is also needed, therefore, is a method that enables a brick and mortar retail business to make their shopping experience as comprehensive and accessible to their potential customers as is available on the Internet.

### SUMMARY OF THE INVENTION

The method of the present invention overcomes the drawbacks of known methods by providing personalized websites to promote targeted marketing for merchants while allowing user/consumers to receive and view information only about products and services that they have specifically requested. The present invention may be used in all retail areas, but is especially effective in large super-regional shopping malls. An advantage of the method of the present invention is that it provides the convenience of Internet based searching to retail “brick and mortar” stores.

The present invention provides a membership based shopping “concierge” method that offers exclusive discounts and convenience to brick and mortar retail shoppers in a user controlled opt-in environment. The present invention utilizes computer networks and database technology to deliver imminent purchasers to participating merchants. To take advantage of exclusive retail discounts, customers agree to provide certain demographic information about themselves and create a user profile of shopping interests, including specific stores, manufacturers, shopping categories, and/or specific products of interest. This shopping profile information is stored in a user/member database. Merchants and/or manufacturers who wish to advertise and sell products to members participate in the program by uploading all or selected current sales items the store is currently offering into the system. In addition, the merchant/manufacturers can entice members with special “members only” discounted items that are not available to the general public.

The method according to an embodiment of the present invention compares member profiles with merchant sales and specials in order to deliver relevant offers to members via a computer network. Products that meet the shoppers profile are displayed via personalized Websites on the Internet or on terminals located in the retail facility. The personalized site, also referred to herein as the Personal Shopping Guide (“PSG”), will filter out all sales and specials that are not relevant to the members interests and lifestyle. While viewing the PSG, a user member can select items the user is interested in purchasing. Selected items are written to a selection database which can be accessed by the merchant's point of sale system. Preferably, a closed loop discount shopping card system is utilized to identify members to the merchant and access discount information from the Selection database. Merchants have the option to set certain purchasing criteria that members must comply with in order to receive the discounts. One preferred criteria would be to provide the selected discount offers of interest to the user only for a predefined period of time, after which the selected discount offers of interest are no longer available to the user.

Broadly stated, the present invention provides a method for providing a user with one or more merchant discount offers, comprising the steps of: obtaining a profile from the user; storing the profile in a user database; storing discount offers received from one or more merchants as data in a merchant database; comparing the profile of the user with the data in the merchant database to identify matches of discounts offered by the merchants that likely may be of interest to the user based on the user profile; creating a personalized shopping guide for the user which lists the matches; displaying the personalized shopping guide to the user; enabling the user to select one or more discount offers of interest from the personalized shopping guide; storing the selected discount offers of interest in a selection database accessible to the user; and enabling a merchant to identify the user and to gain access to the selection database at the point of sale.

An object of the invention is to provide more cost effective advertising for merchants, manufacturers, and mall ownership companies so as to reduce their reliance on low percentage response advertising methods such as telemarketing, direct mail, and unsolicited email. Another object of the invention is to create a permission based interactive dialog between merchants and shoppers. A further object of the invention is to provide membership services to shoppers in order to attract repeat customers. Another object of the invention is to simplify the shopping experience for a user.

An object of the invention is to provide membership shopping discounts not available to the general public. Another object of the present invention is to provide an opt-in system for delivering commercial messages and discount offers and incentives to consumers that enables the consumers to readily and more immediately redeem them.

An object of the present invention is to provide a method that provides personalized Websites to eliminate the negative issues associated with email marketing and provide a much more robust format for presenting shopping opportunities. Another object of the present invention is to provide a method that uses profiling such that a user only receives opt-in merchant offers for which the user has indicated an interest. Another object is to enable the user to edit and change their personal profile at any time. Still another object of the present invention is to deliver discount offers and associated advertising to consumers via the World Wide Web.

These and other embodiments, features, aspects, and advantages of the invention will become better understood with regard to the following description, appended claims, and accompanying drawings.

### BRIEF DESCRIPTION OF THE DRAWINGS

The aforementioned and related advantages and features of the present invention will become apparent upon review of the following detailed description of the invention, taken in conjunction with the following drawings, where like numerals represent like elements, in which:

FIG. 1 is a flow chart of an exemplary merchant setup process according to an embodiment of the method of the present invention;

FIG. 2 is a flow chart illustrating further detail regarding the step for merchant uploading of data shown in FIG. 1;

FIG. 3 is flow chart illustrating an exemplary membership process according to an embodiment of the method of the present invention;

FIG. 4 is a flow chart illustrating an exemplary logon process for members according to an embodiment of the method of the present invention;

FIG. 5 is a flow chart illustrating an exemplary process wherein a user can select discount offers of interest from a personalized shopping guide according to an embodiment of the method of the present invention;

FIG. 6 is a flow chart illustrating an exemplary purchase process for discount offer items at the point of sale according to an embodiment of the method of the present invention;

FIG. 7 is a flow chart illustrating a checkout process after discounted items are purchased at the point of sale according to an exemplary embodiment of the method of the present invention; and

FIG. 8 is a flowchart depicting an exemplary process for setting up a “wish list” of selected items of interest when a discount offer becomes available according to an embodiment of the method of the present invention.

### DETAILED DESCRIPTION OF THE INVENTION

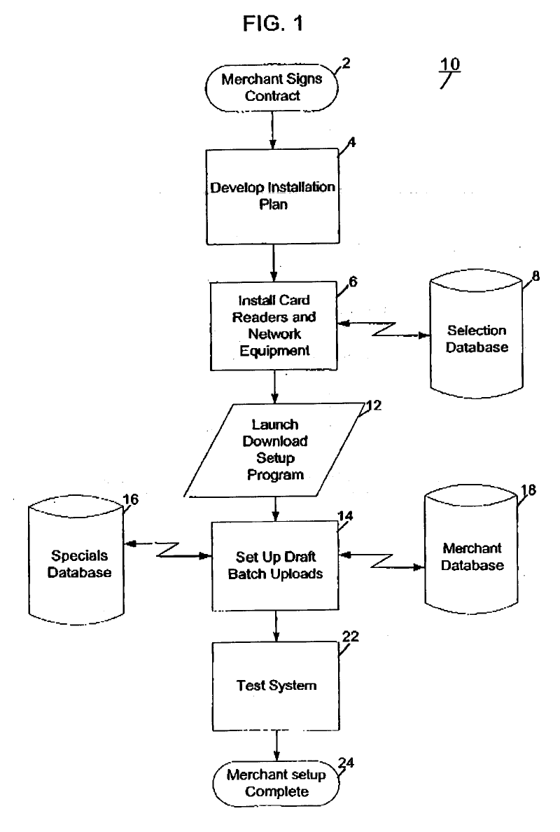

The present invention overcomes the drawbacks of the known methods. Embodiments of the present invention will be described in further detail with reference to FIGS. 1-8. The present invention will also be described with the use of examples of a beneficial use of the present invention that overcomes drawback of the present methods; however, the present invention is not limited to the examples.

The present invention has the advantage of providing an additional advertising venue for participating mall-based merchants and other merchants to promote their discounted sale items. In order to begin participating, a merchant must go through a setup process.

FIG. 1 is a flow chart of an exemplary setup process 10 for a new merchant according to an embodiment of the method of the present invention. In Step 2, the new merchant who wishes to participate signs a suitable contract in order to enter into an agreement with an operator of the method. In order to be eligible to participate in the program, merchants must agree to provide special offers to the operator's members that are not available to the general public. New merchants must also agree to install suitable equipment at each of the participating stores as required by the method and as will be described in further detail below. Alternatively, suitable existing Point of Sale (“POS”) equipment may be used for practicing the method of the present invention. In addition, participating merchants agree to accept and process discount cards or the like and to provide additional discounts to the operator's members. Other terms of the agreement will be described in more detail below.

After the contract is in place, a setup team evaluates the merchant's internal processes and procedures. In Step 4, an installation plan is developed to provide the logistics needed to setup the merchant's system to enable participation in the method. In Step 6, electronic card readers or the like and suitable network equipment are installed at the merchant's retail store if suitable equipment is not already available at the store. Preferably, a magnetic card is presented by a user and read by the card reader at the merchant's retail store. For example, POS card readers are installed at each of the check out stands in the merchant's store for reading an electronic card or the like used by the user at a point of sale to obtain a selected discount. The POS readers are preferably connected by some means to the merchant's computer system. The present invention is not limited to the use of electronic cards. Alternatively, other means, electronic and otherwise, of presentation from a user for reading at a merchant's location may be used to practice the present invention.

The network equipment in Step 6 is set up to enable two-way connectivity over a global computer network such as the Internet with a Selection Database 8. Access to the Selection Database 8 from the card readers is then made available via the network. The Selection Database 8 is connected to the network and accessible to the merchant's system and the operator's system. Preferably, the Selection Database 8 is resident on the operator's system.

In Step 12, downloading of a setup program is launched for download from the operator's system to the merchant system. Once the setup program is successfully downloaded, it is installed and executed on the merchant's system. The setup program sets up a Merchant Database 18 and a Specials Database 16 and formats the batch files that will be preferably used for the regular upload of sales and member only specials. The term “DB” is also used herein to refer to the word “database”, e.g., Merchant DB 18.

In Step 14, a setup for uploads of the new merchant's data commences for data transfer to the operator's system. For the exemplary embodiment in FIG. 1, the uploaded merchant data is loaded into either a Specials Database 16 or a Merchant Database 18. Standard sales item information is uploaded to the Merchants Database 18 preferably at predetermined intervals in order to maintain current data in the database. Preferably, the data uploaded to the Merchant Database 18 is very similar to the advertising data the merchant would pay to have included in a local newspaper or other media, for example. Alternatively, the standard sales data loaded into the Merchant Database 18 is converted from paper based ads that have already been produced.

Participating merchants must agree to and submit special discounts for items, also referred to herein as “specials” or “special discounts”. The special discounts are in addition to standard sales items available in newspaper advertisements or other advertisements made known to the general public. For the embodiment in FIG. 1, the data corresponding to these special discounts is uploaded or otherwise entered into the Specials Database 16. The special discounts are discounts which are not available to the general public. The discount may be provided for an item for which no discounts are available to the general public. Alternatively, the discount may be a discount above the advertised sale discount. For example, an advertisement for the general public may specify a 20% discount on a particular item, and the members-only special discount provides a 30% discount on that same item.

In a preferred embodiment, the Merchant Database 18 includes the members only special discount information in addition to the standard sales information such that a separate Specials Database 16 is not required.

In Step 22, a system test is performed to validate the set up, and upon completion at Step 24, the setup for the participating merchant is complete for this stage. For Step 22, the system test will test the entire process, including uploading sales information to the Merchant Database 18, uploading member's only specials to the Specials Database 16, and accessing the Selection Database 8 from the merchant's point of sale system(s). Upon successful completion of the system test in Step 22, the merchant setup is completed, as shown in Step 24 in FIG. 1.

For a preferred embodiment of the method of the present invention, in Step 2, the new merchant agrees: to set up a process to upload standard sales information to the Merchants Database 18, to upload the standard sales information on a regular basis at predetermined intervals; to make “members only” sales items, also referred to herein as “Sales” items, available to the operator's members; to set up a process to upload “members only” sales information to the Specials Database 16, to upload the “members only” sales items, also referred to herein as “Special” items or “Specials”, to the Specials Database 16 on a regular basis; to install Point of Sale card readers or the like at every check out stand in the merchant's store; to facilitate the swiping of the member's card when requested by the member/customer; to allow the card swipe to activate a program that compares purchased items at the check out stand to the Selection Database 8 for matches, and if matches occur, the merchant agrees to communicate this information to the operator's system; and to apply any required discounts as stated in the Selections Database 8.

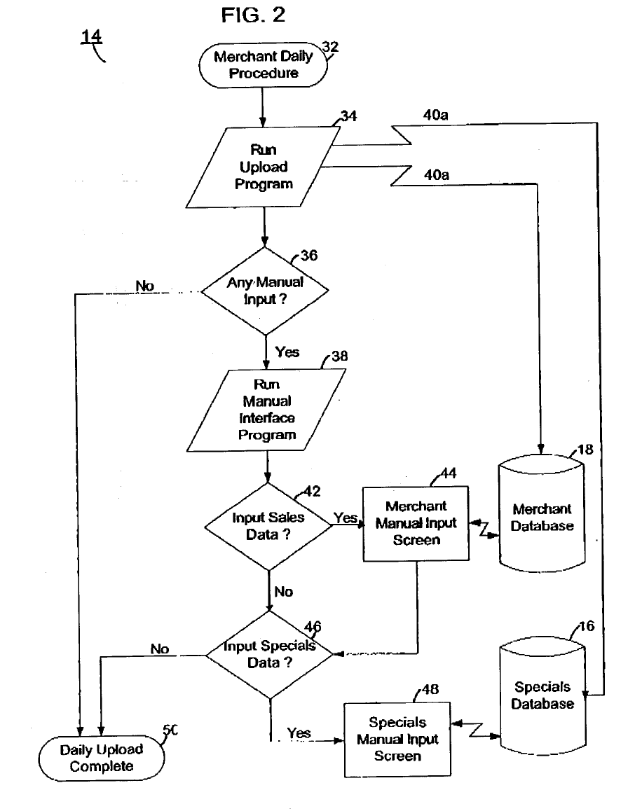

FIG. 2 is a flow chart illustrating further details regarding the merchant uploading of data shown in Step 14 of the exemplary embodiment in FIG. 1. Once the merchant set up process in FIG. 1 is completed, the merchant is setup to start submitting uploads of sales and specials data to the databases. The uploads are submitted at predetermined intervals. The uploads preferably are done on a daily basis as shown beginning in Step 32 in the exemplary embodiment shown in FIG. 2.

As seen in FIG. 2, at Step 34, an upload program is run for uploading merchant sales information to the Merchants Database 18 and member's only sales information to the Specials Database 16. The upload program is executed in one of a manual or automated batch mode or a combination thereof as shown in FIG. 2. In a batch upload mode, existing digital files and text used in the merchant's catalog, newspaper ads, or the like is uploaded automatically to the operator's system at predetermined intervals. For the batch upload, the flow to the Specials Database 16 is shown at 40a and the flow to the Member Database 18 is shown at 40b in FIG. 2. The Member Database 18 is also referred to as the User Database 18. The operator's system receives the information from the two databases and converts it into searchable format that is preferably a web based format. An online interface is provided for the alternative manual input of sales information and graphic data into the Merchant Database 18 in the operator's system.

After the program completes an automated batch upload at 40a and 40b, in Step 36, the participating merchant is prompted for any manual input of all or part of the sales data to be uploaded. If the merchant indicates that there is no manual input required, the flow proceeds to Step 50 and the daily upload is completed. If the merchant indicates that there is manual input required, at Step 38, a program, referred to herein as a manual interface program, is executed. In Step 42, the manual interface program prompts the merchant for an indication of whether manual input of standard sales data is required. In Step 44, a merchant manual input screen is presented to the merchant if the merchant indicates that manual input of standard sales data is required. The standard sales data entered by the merchant is input to the Merchant Database 18. It should be appreciated for the present invention that references to the “merchant” entering data manually refer to the merchant or someone on behalf of the merchant entering the data manually.

If the merchant indicates in Step 42 that there is no input sales data to be manually input or if the manual input in Step 44 is completed, then Step 46 is executed. In Step 46, the merchant is prompted for an indication of whether manual input of specials data is required.

In Step 48, a specials manual input screen is presented to the merchant if the merchant indicates that manual input of specials data is required. The specials data entered by the merchant is input to the Specials Database 16. If the merchant indicates in Step 46 that there is no input specials data to be manually input or if the manual input in Step 48 is completed, the daily upload procedure is completed, at Step 50. Preferably, the manual interface program is executed as a stand alone program whenever manual input is required.

In contrast to known methods, the method of the present invention is directed towards offline or “brick and mortar” stores and their shoppers, particularly in shopping malls. Shopping malls shoppers are typically not solely focused on finding the cheapest price in the shortest amount of time. The mall shoppers typically enjoy spending time at the mall to browse, purchase, and socialize. Mall shoppers are price conscious, but prefer to purchase in-person rather than sight unseen on the Internet or other means. The average size of the 200 largest malls in the U.S. is approximately 1.3 million square feet. This enormity provides much territory for a shopper to cover when searching for good buys. One advantage to online shopping is the ability to use search engines to quickly find the best price for any particular items. The method of the present invention brings the advantage of search engine technology to offline shoppers.

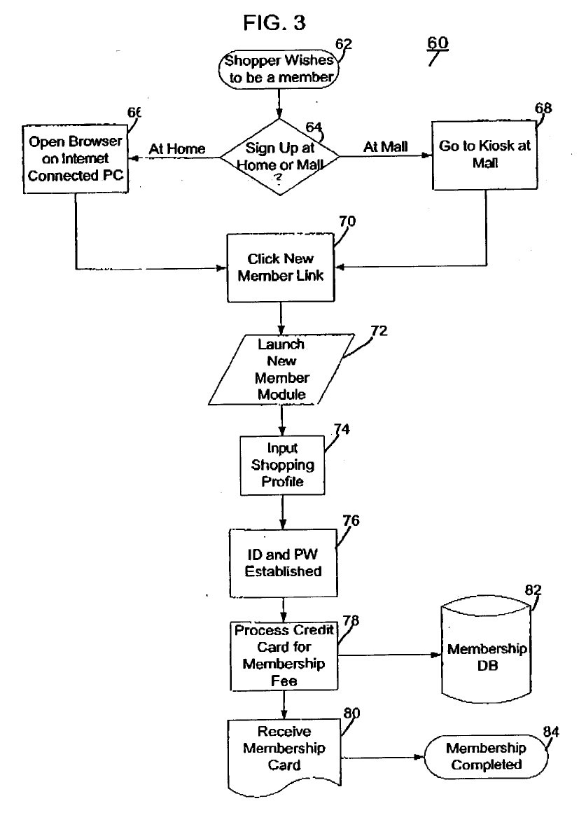

The first step to enable a shopper/customer to take advantage of membership services provided by the present invention is to sign up the shopper as a member. FIG. 3 is flow chart illustrating an exemplary membership process 60 according to an embodiment of the method of the present invention. In Step 62, a shopper wishes to become a member. The method of the present invention allows the shopper to sign up for membership in two ways. In the exemplary embodiment shown in FIG. 3, in Step 64, the method allows a shopper to sign up for membership at the mall. In Step 64, the method also allows a shopper to sign up away from the mall, e.g., at home. In Step 68, for signup at the mall, a shopper goes to a kiosk at predetermined locations in a participating shopping mall in order to signup. In Step 66, for signup away from the mall, the method allows a shopper to sign up using any Internet connected computing device. Preferably, the computing device is a personal computer (PC) although any suitable computing device can be used to practice the invention.

The remaining signup steps in FIG. 3 apply regardless of whether a shopper/user signs up online or at the mall kiosk. The signup process procedure starts at Step 70 after the user opens a browser on the Internet connected PC to a predetermined website or is at the mall kiosk. At Step 70, the shopper/user selects a link for new members, preferably referred to as a “new member” link as in FIG. 3, although any suitable designation may be used. In response to the users selection of the new member link in Step 70, a module for processing new members is executed, e.g. a new member module. The new member module presents information to the user which will explain the benefits of the membership program along with information on how to use the system.

In Step 74, the user is prompted to input a shopping profile. Step 74 comprises prompting the user with a series of questions, the answers to which will be used to build a user's profile for the particular user. The user is prompted to enter his/her standard demographic information. The sign up program preferably queries the user about their particular shopping habits including asking the user to identify categories of goods and services the user usually purchases, preferred brands, manufacturers, and supplier, and which local stores in the mall the user frequents. Preferably, the method enables the user to respond to this query via mouse clicks of boxes on the display in order to reduce time and typing. This profile will be the basis for which promotions will be presented to the user via a Personalized Shopping Guide (PSG).

In Step 76, the step of obtaining a profile from the user includes assigning a unique identifier to the user. Any suitable identifier may be used. Preferably, the user's identifier includes a unique identifier code (ID) and password (PW) as shown in Step 76 of the exemplary embodiment in FIG. 3. The identifier, e.g., ID and password, will be required for the user to access the membership system in the future.

A user is preferably required to pay an annual fee in order to remain an active member. Alternatively, the membership fee is not required. In Step 78, the user's credit card or the like is processed in order to pay any required annual membership fee. For the exemplary embodiment in FIG. 3, a credit card payment is shown as an example. Debit cards, online checking account transfer, or other suitable means may also used by a user to pay the membership fee. The profile and identifier data are written to a Members Database 82 after the payment has been accepted, i.e., after credit card information has been processed and the charges approved. In Step 80, a membership card is given to the user by some suitable means after payment has been accepted. The membership process is completed in Step 84 after the membership card has been received by the user. The membership card provided to a member user is preferably a magnetic strip card that is readable at the merchant store by suitable means. Alternatively, the membership card comprises an electronic multi-function card or a memory card capable of storing at least the user identifier. The card also preferably is able to store additional information regarding discount offers of interest as will be explained in further detail below.

The Merchant Database 18 includes data of items on sale on a daily basis for all the participating merchants. The Specials Database 16 includes data of members-only special discounts. The Members Database 82 includes data of all the members along with their shopping profiles and alternatively, their shopping history. After a member logs into the system, the profile of the user is compared with data in the Merchant Database 18 to identify matches of discounts offered by the merchants that likely may be of interest to the user based on the user profile. A personalized shopping guide is created for the user which lists the matches. The personalized shopping guide is displayed to the user;

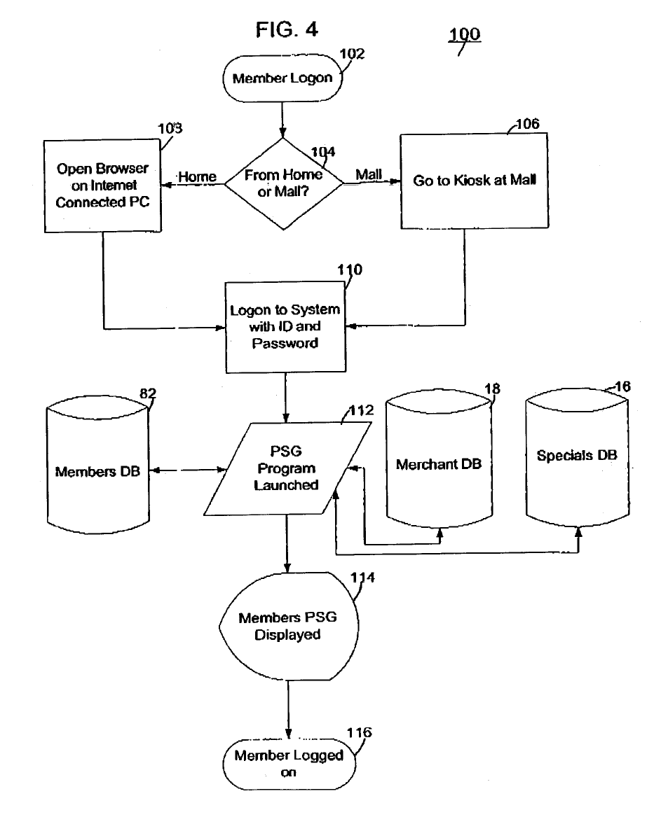

FIG. 4 is a flow chart illustrating an exemplary member initial logon process according to an embodiment of the method of the present invention. In Step 102, the member logon begins. In Step 104, the method, according to a preferred embodiment, allows a shopper to logon at the merchant store, shown as the “mall” in the example in FIG. 4. In Step 104, alternatively, the member logs on from a location away from the mall, e.g. shown as “home” in FIG. 4. In Step 106, for logon at the mall, the user proceeds to the kiosk at predetermined locations in the participating shopping mall. In Step 108, for logon away from the mall, the method allows the user to logon using any Internet connected computing device. Preferably, the computing device is a PC although any suitable computing device can be used to practice the invention.

The remaining steps of the member logon process 100 do not depend on the means used by the user to logon. The logon process procedure starts at Step 110 after the user opens a browser on the Internet connected PC to a predetermined website or is at the mall kiosk. At Step 110, the user enters their identifier. Preferably, the identifier includes a unique identifier code (ID) and a password as shown in Step 110 of the exemplary embodiment in FIG. 4.

After the identifier is input by the user, in Step 112, a module, shown as the PSG program in the exemplary embodiment in FIG. 4, is launched for execution to create the PSG for the user. The module compares the profile of the user from the Members DB 82 with data in the Merchant DB 18 and the Specials DB 16 to identify matches of discounts offered by participating merchants that likely may be of interest to the user based on the user profile. According to a preferred embodiment of the method of the present invention, the Merchant Database 18 includes the members-only special discount information in addition to the standard sales information, such that a separate Specials Database 16 is not required.

Alternatively, the profile of the user includes demographic information provided by the user, the shopping profile, and shopping history of the user. During profile creation at Step 74 in FIG. 3, the method allows the prospective member to opt out of having selected information compiled by the method. The shopping history preferably includes a history of purchases of the member at the participating merchants. For example, the method preferably allows the user to designate that his/her shopping history information will not be compiled. The method enables a user to have some control of the profile such as the ability to edit and change their profile at any time. The method also enables the user to opt in or opt out from having certain information, such as previous buying history and patterns for example, from being used by the method. The method does require that certain predetermined information be supplied by the user in order for the user to become a member and that this information be provided and available to the method. This predetermined information includes a set of products and/or service preferences of the user. Alternatively, the predetermined information also includes a set of merchants of interest to the user.

According to a preferred embodiment, when a consumer signs up for a membership, he or she is required to provide basic demographic information about themselves and to fill out a survey that asks specific questions about his or her shopping habits. The consumer is also asked about preferences for any specific stores, brands, or categories of goods and services that the consumer wishes to be notified about. From this data, a profile is created that is used in Step 112 to create the member's custom PSG. The method of the present invention enables members to log on at any time and change their profile or add specific products and/or stores they wish to monitor.

In Step 112, a personalized shopping guide is created for the user which lists the matches. In Step 114, the personalized shopping guide of the user/member is displayed to the user. It should be appreciated that once a “user” becomes a “member”, the term “user” and “member” become interchangeable. In Step 116, the initial logon is complete, shown as “member logged on” in FIG. 4, after the personalized shopping guide is displayed to the user. The method provides a personalized shopping guide in a default format for all new members who logon for the first time. Preferably, users are presented with a number of options for use in tailoring the layout and content of the PSG according to the user's preference.

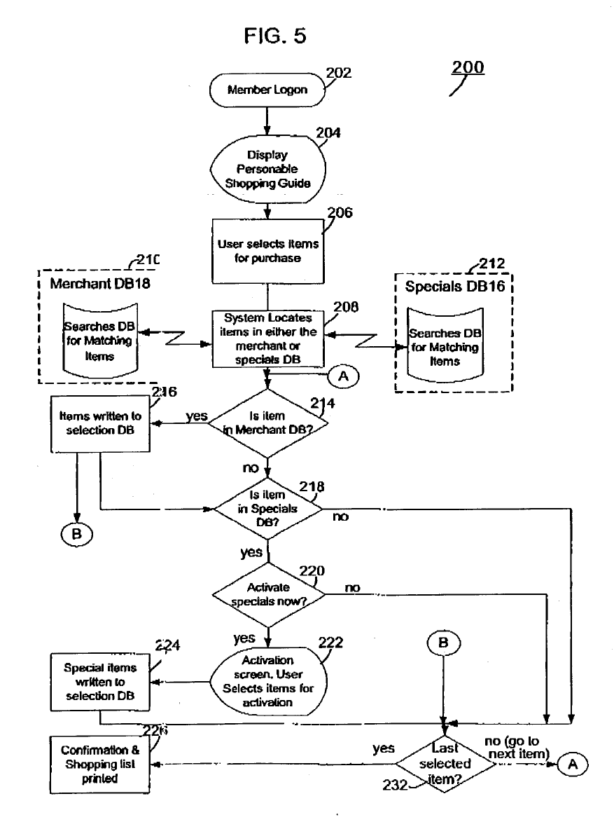

According to a preferred embodiment of the method of the present invention, after the user is logged in, the method enables the user to select one or more discount offers of interest from the personalized shopping guide as is described in further detail below with reference to FIGS. 5-8.

FIG. 5 is a flow chart illustrating further details of an exemplary process wherein a user can select discount offers of interest from a personalized shopping guide according to an embodiment of the method of the present invention. The method of the present invention enables the user to select one or more discount offers of interest from his/her personalized shopping guide. In Step 202, it is assumed that the member has logged on in accordance with the process shown in FIG. 4. In Step 204, it is assumed that the personalized shopping guide is displayed to the user as shown at Step 114 in FIG. 4. The method enables the user to select one or more discount offers of interest from the personalized shopping guide. If a user wishes to select a Special item for later purchase at the merchant store, the item must first be selected. In Step 206, a user selects items for purchase from the personalized shopping guide. Preferably, check boxes or other suitable icons are provided on the display to allow the user to quickly select the items, via a mouse click for example, that the user plans to purchase.

In Steps 210 and 212, the method compares each user selected item with data in the Merchant DB 18 and the Specials DB 16 to locate the item. In Step 214, it is determined whether it is confirmed that the selected item data is in the Merchant DB 18. If the selected item data is in the Merchant DB 18, in Step 216 the item data is written to the Selection DB 8 and the process proceeds to Step 232, where if the current item is the last selected item, the process proceeds to Step 226 such that a confirmation message is preferably displayed to the user, a printable shopping list is presented to the user for the confirmed selected and activated items, and the process 200 is terminated. If a selected item is not in the Merchant database, it is located in the Specials database since selected items originate from either of these two databases. The process proceeds to Step 218 if the selected item data is not found in the Merchant DB 18. In Step 218, a determination is made as to whether it is confirmed that the selected item data is in a Specials DB 16. Alternatively, if the selected item data is not in the Merchant DB 18, the item data is written to the Selection DB 8 and the method enables the user to continue searching in Step 206 for items to select.

Special items which are stored in the Specials Database 16 are processed differently than standard Sales items which are stored in the Merchant Database 18. In the preferred embodiment of the invention, the separate Specials database 16 is eliminated and both Sales and Special items are stored in the Merchant Database 18. For Special items, the merchant has agreed to provide additional discounts to member users that are not available to the general public. These Specials are preferably available to the user for a predefined period of time, after which time the Specials are no longer available to the user. The predefined time can range from a few hours to a few days, for instance. The predefined time is preferably determined by the merchant. Alternatively, the predefined time is determined by the operator of the method as a function of the particular item and the corresponding merchant. The method tracks the time on limited offers. Standard Sales items stored in the Merchant Database 18 are available only as long as the sales items remain there. Therefore, unlike selected Special items, selected Sales items do not require an activation process. After the user activates a time sensitive “members only” Special, the method updates the Selection DB 8 with the members identifier and time stamps when the selected Special item was activated. When the member goes to the merchant to purchase the item, the merchant has access to the Selection database such that the system verifies whether a member has selected an item for purchase and at what time the selection was activated. If the item is not purchased within the predefined allowed time frame, the member reference information corresponding to the activated Special item is deleted from the Selection DB 8, and as a result, the selected Special discount is deactivated, i.e. no longer available to the user.

According to a preferred embodiment of the method of the present invention, the Merchant Database 18 includes the “members only” special discount information in addition to the standard sales information, such that a separate Specials Database 16, and search thereof, is not required.

In Step 220, the method queries the user as to whether he/she wishes to activate the specials if the user selected item is in the Specials DB 16. In response to an indication from the user that he/she does not wish to activate the specials now, Step 232 is executed, otherwise, Step 222 is executed. In Step 232, the process proceeds to Step 226 if the last selected item has been processed, otherwise the process returns to Step 214 to process the next selected item. In Step 226, a confirmation message is preferably displayed to the user, a printable shopping list is presented to the user for the confirmed selected and activated items, and then the process 200 is terminated. In Step 222, an activation screen is presented to the user which enables the user to select “members only” specials for activation if specials have been activated in Step 220. In response to the user selection of the Special items for activation, in Step 224, the activated Special items along with the activation date and time are written to the Selection DB 8 and the process proceeds to Step 232. Preferably, the predefined period of time during which a special discount offer is available begins at the point in time when the program writes the activation date and time to the Selection DB 8.

According to an alternate embodiment, the beginning of the predefined period of time begins at a point in time as a function of the user performing a predetermined action. If, in Step 220, the user does not wish to activate the activation process, according to the alternate embodiment of the present invention, the method allows the user to activate the special discount at a later time. For example, according to the alternate embodiment, a user can make selections at home via an Internet connected device and then activate the offer via a kiosk in the mall after the user arrives at the mall. According to an alternate embodiment, the predetermined action is an entry by the user of his/her identifier. In yet another embodiment, the predetermined action is the receiving of the membership card by the user. Preferably, all special discounts are time sensitive and therefore the user must activate the special during a logon session such that the predefined availability time is initiated, otherwise the special discount is not available to the user.

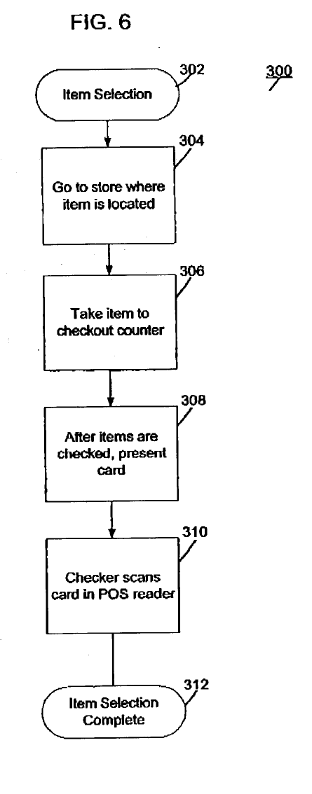

FIG. 6 is a flow chart illustrating an exemplary purchase process 300 of a discount offer items at the point of sale according to an embodiment of the method of the present invention. FIG. 6 illustrates an example of a use of the present invention and assumes, in Step 302, that the user has selected an item as shown in FIG. 5. In Step 304, the user goes to a merchant's store where the selected item is located. Preferably, the store is in a mall since the method of the present invention is very advantageous for a mall venue. For example, the user may have a printout of the shopping list generated in Step 226 in FIG. 5, and proceed to find one or more items on the list in the particular store. According to the embodiment of the exemplary method of the present invention shown in FIG. 5, a shopping list is preferably provided to the member in Step 226 as a convenience only and is not required for completion of the purchase of either a sales or special item. Alternatively, the shopping list is not provided to the user or is provided to the user using electronic and/or wireless means rather than using printing means. The user then preferably “presents” the selected item to a checkout counter in the store. It should be appreciated that depending on the size and bulk of the item, other suitable means, such as presenting a store's item tag or other document may be used for “presenting” the selected item at the checkout counter. In Step 308 of the exemplary embodiment in FIG. 6, after the items are checked by a store clerk “checker”, the user presents his/her membership card to the checker. In Step 310, the membership card is scanned into a suitable POS reader by the checker or alternatively by the user. In Step 312, the item selection at the store is complete.

The membership card is preferably a closed loop card system which can be read and interpreted by the POS system installed in Step 6 of FIG. 1 in each of the participating merchants. Alternatively, the membership card is a memory card, smart card, or a suitable wireless device that contains the member's unique identifier. Alternatively, for practicing the method of the present invention, the member's identifier may be entered via suitable entry means such as a POS keypad.

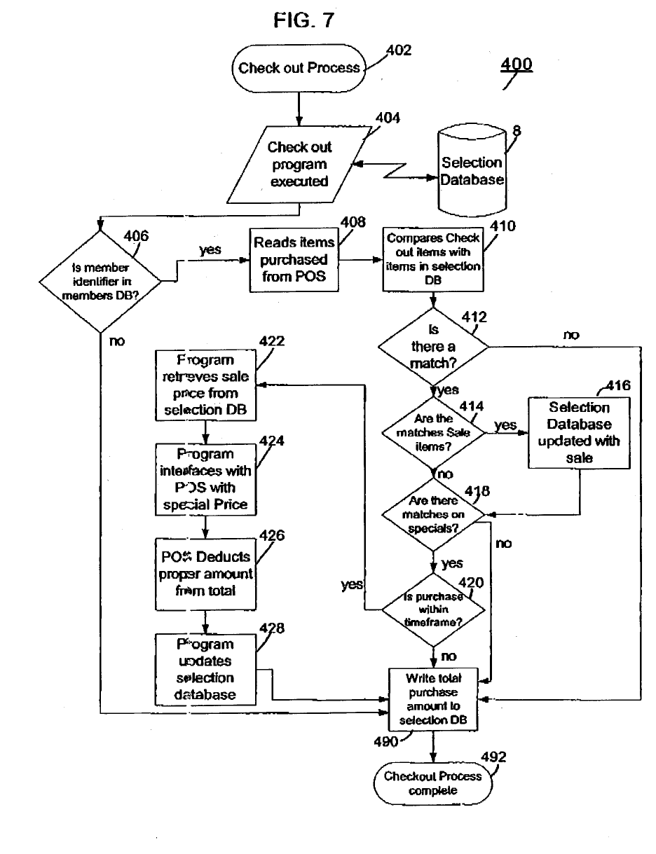

The scanning or swiping of the membership card in Step 310 in FIG. 6 begins a “check out” procedure which executes a series of processes as shown in the exemplary embodiment in FIG. 7. FIG. 7 is a flow chart illustrating a checkout process 400 after discounted items are purchased at the point of sale according to an exemplary embodiment of the method of the present invention. In Step 402, the exemplary check out process begins. In Step 404, code, identified as the “check out program” in the example in FIG. 7, is executed in order to process the checkout transaction. In Step 404, a connection is made between the merchant's POS system and the Selection Database 8. In Step 404, a member identifier as read from the membership card at the POS system and a determination is made as to whether the member identifier is a valid and current member identifier in the Members DB 82. A member identifier is not current if the member, for example, has allowed the membership to expire by not paying membership fees as required. If the “read” member identifier that was read is determined not to be a valid and current member identifier, Step 490 is executed. In Step 490, the total purchase amount is written to the Selection DB 8 and then the checkout process is complete as shown at Step 492. Preferably, three pieces of data are tracked in relation to a purchase at a participating merchant including: special items purchased, sales items purchased, and total amount of goods and services purchased.

If it is determined that the “read” member ID from the card is valid and current, in Step 408, the check out items purchased from the POS are read. Next, in Step 410, the check out items are compared with item data in the Selection DB 8. During the item selection process 300 in FIG. 6, data for the transaction according to the method of present invention is written to the Selection DB 8 including the member identifier. Therefore, the POS only needs access to the Selection DB 8 for Step 410. In a preferred embodiment, all the data from the Selection Database and the Members database would be combined into one location, preferably the Members database, such that the POS would only need access to the Members database. In Step 406, a determination is made as to whether the user identifier, e.g., member ID, from the card or the like is found in the Selection DB 8 or, in the preferred embodiment, the Members Database 82 In Step 408, items purchased from POS terminal are read if the user identifier is found in the Members Database 82, otherwise the process proceeds to Step 490.

After the items purchases are read in Step 408, the process proceeds to Step 410. In Step 410, the data for the checkout items is compared with data in the Selection DB 8. After the comparison in Step 410 is made, in Step 412 a determination is made as to whether there is a match between each checkout item and data for the items in the Selection DB 8. If there is not a match in Step 412, the total purchase amount is written to the Selection DB 8 as shown in Step 490 and then the checkout process is complete as shown at Step 492.

In Step 414, a determination is made as to whether the matched item is a standard sales item if there was a match in Step 412. If there are any matched items that are standard sales items, in Step 416, the Selection DB 8 is updated with the sales information for each matched item that is a standard sales item, and the process proceeds to Step 418. In Step 418, a determination is made as to whether any matched items are special discount items. If no matched items are special discount items in Step 418, Step 490 is executed such that the total purchase amount is written to the Selection DB 8 and then the checkout process is complete at Step 492.

Step 420 is executed if any matched items are special discount items in Step 418. In Step 420, a determination is made as to whether the purchase of any special discount items was made by the user within the predefined period of time after which the selected discount offer is no longer available to the user. The date and time of the purchase are compared with the predefined period of time to determine if the purchase is made within the predefined time period. For example, if a special discount item was activated at 10:30 a.m. based on a user action and the predefined period of time was two hours, a user purchase of that special discount item at noon would be within the predefined period of time.

If it is determined in Step 420 that no purchase of special discount items was made within the predefined time, Step 490 is executed such that the total purchase amount is written to the Selection DB 8 and then the checkout process is complete at Step 492. If it is determined in Step 420 that at least one purchase of special discount items was made within the predefined time, Step 422 is executed. In Step 422, for each special discount item, the special sales price, also referred to herein as the “special price” or “special discount price”, information is retrieved from the Selection DB 8. After Step 422, in Step 424, an interface made with the POS at the merchant location for a transfer to the POS and the special price information is sent to the POS via the interface. After the special price information is received by the POS, in Step 426, the POS deducts the proper amount of the discounts corresponding to the special price from the total amount of the bill owed by the user purchaser. After Step 426 is executed, in Step 428, the Selection Database 8 is updated with the transaction information and then the total purchase amount is written to the Selection DB 8 in Step 490 and the checkout process completes at Step 492.

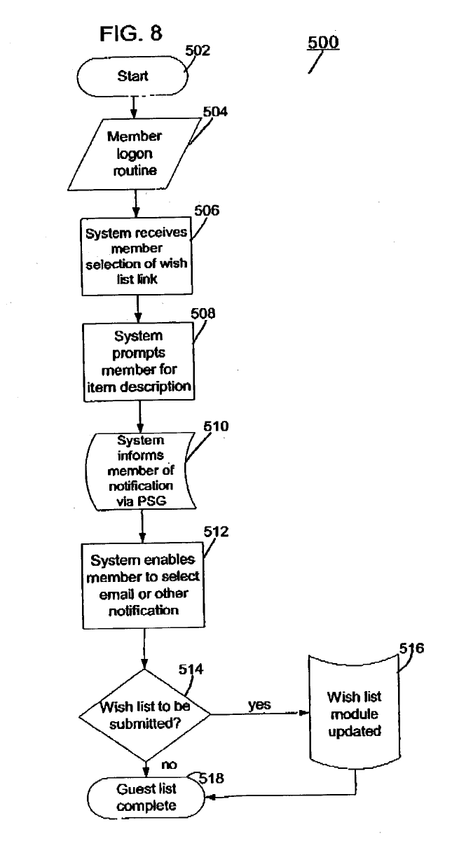

A user may have an interest in an item that is not currently discounted. FIG. 8 is a flowchart depicting an exemplary process for setting up a “wish list” of selected items of interest when a discount offer becomes available according to an embodiment of the method of the present invention. Step 502 indicates the starting point of the “wish list” process. In Step 504, the member logs on and the corresponding routine to process the logon is executed. FIG. 4 illustrates an exemplary embodiments including the logon process. After logon, the user's personalized shopping guide is displayed. In Step 506, in order to setup a wish list, the method provides a wish list link displayed on the personalized shopping guide and enables the user member to select the wish list link. In Step 508, in response to user selection of the wish list link, the method enables the user member to select one or more products and/or services that are of interest to the user only when a corresponding discount offer for the selected products and/or services becomes available, e.g., when a sale starts such that the item becomes available at a reduced price. In Step 508, the system prompts the user for an item description. Preferably, in Step 508, the method of the present invention allows users to select items the user wishes to purchase in the future when the item is offered at a discounted sale price. In an alternate embodiment, the method enables the user to input purchase criteria and a list of selected items is derived therefrom. It should be appreciated that the selected item could be a product and/or a service; e.g., a large screen plasma television and installation thereof. The method stores the selection of one or more products and/or services as a “wish list” in the Member (user) Database 18.

In Step 510, the method indicates to the user that the user will be notified of wish list matches on the user's personalized shopping guide. Wish list matches are listed in the user's personalized shopping guide to enable selection of one or more of the corresponding discount offers by the user. In Step 512, the method queries the user as to whether he/she wishes to also receive notification by email. In an alternative embodiment, the method enables a user to choose to receive notification on a wireless device through means other than email, providing that the user provide the necessary information to enable the method to transmit to the device. It should be appreciated that the email notification requires that the user provides an email address. The user may provide the email address when requesting email notification. Alternately, the user's email address is provided by the user as part of the user's profile.

After the user indicates whether he/she wishes email notification, in Step 514, the user is queried as to whether he/she wishes to submit the wish list. Preferably, the user is allowed to submit an update to an existing wish list. If the user indicates that he/she wishes to submit the wish list, the wish list process proceeds to Step 516, otherwise the process is completed at Step 518. In Step 516, the wish list for the user is stored, or, if the user was updating an existing wish list, the existing stored wish list is updated.

Once the wish list is submitted and stored, the method periodically monitors and compares the selected one or more products and/or services with the data in the Merchant Database 18 to identify wish list matches of the wish list of selected products and/or services and the currently available discount offers. When a wish list match is identified, the method notifies the user. The wish list matches are listed in the personalized shopping guide to enable selection of one or more of the corresponding discount offers by the user. Alternatively, if the user has previously designated that he/she wishes to receive notification by email also, an email is sent to the user when the wish list match is identified.

In an alternate embodiment, a “guest” view is provided which enables a non-member to search for any sales items in all the stores in the Merchant Database 18.

Although specific embodiments of the invention have been described, various modifications, alterations, alternative constructions, and equivalents are also encompassed within the scope of the invention. The described invention is not restricted to operation within certain specific data processing environments, but is free to operate within a plurality of data processing environments. Additionally, although the invention has been described using a particular series of transactions and steps, it should be apparent to those skilled in the art that the scope of the invention is not limited to the described series of transactions and steps.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention as set forth in the claims.

1. A method for providing a user with one or more merchant discount offers, comprising the steps of:
obtaining a profile from said user;
storing said profile in a user database;
storing discount offers received from one or more merchants as data in a merchant database;
comparing said profile of said user with said data in said merchant database to identify matches of discounts offered by said merchants that likely may be of interest to said user based on said user profile;
creating a personalized shopping guide for said user which lists said matches;
displaying said personalized shopping guide to said user;
enabling said user to select one or more discount offers of interest from said personalized shopping guide;
storing said selected discount offers of interest in a selection database accessible to said user; and
enabling a merchant to identify said user and to gain access to said selection database at the point of sale.

2. The method of claim 1, wherein said step of storing said selected discount offers of interest in a selection database comprises downloading said selected discount offers of interest onto an electronic card or the like for use by said user at a point of sale to obtain the selected discount.

3. The method of claim 1, wherein the step of obtaining a profile from said user includes assigning a unique identifier to said user and wherein said selected discount offers of interest are available to said user for a predefined period of time after which said selected discount offers of interest are no longer available to said user.

4. The method of claim 3, wherein the beginning of said predefined period of time begins at a point in time as a function of said user performing a predetermined action.

5. The method of claim 4, further comprising the step of providing said identifier to said user on a magnetic strip card, wherein said predetermined action is the receiving of said card by said user.

6. The method of claim 4, further comprising providing said identifier to said user on a magnetic strip card, wherein said predetermined action is said user having said card read by a card reader.

7. The method of claim 4, further comprising providing said identifier to said user on a magnetic strip card, wherein said predetermined action is an entry by said user of said identifier.

8. The method of claim 7, wherein said identifier is an identification code and a password.

9. The method of claim 3, wherein said predefined period of time begins at the point in time when said selected discount offers of interest are stored in said selection database.

10. The method of claim 1, further comprising obtaining from said merchants a data record of each purchase made by said user that utilized one or more of said selected discount offers of interest and storing said data as part of said user's profile in said user database.

11. The method of claim 1, wherein said selection database is accessible to said user via a global computer network.

12. The method of claim 1, wherein said selection database is accessible to said user via a wireless device.

13. The method of claim 1, further comprising the step of providing said user with additional discounts or other awards based on the number of discount offers of interest utilized by said user.

14. The method of claim 1, further causing a predetermined fee to be charged to a merchant based on use by said user of one or more of said discount offers of said merchant.

15. The method of claim 1, wherein said profile comprises a set of products and/or service preferences.

16. The method of claim 15, wherein said profile further comprises a set of merchants.

17. The method of claim 1, wherein the step of obtaining a profile from said user includes assigning a unique identifier to said user.

18. The method of claim 17, wherein said unique identifier is comprised of alphanumeric characters.

19. The method of claim 17, wherein said unique identifier is one or more characteristics of said user.

20. The method of claim 17, wherein said step of comparing said profile includes comparing said profile of said user based on said identifier of said user with said data in said merchant database.

21. The method of claim 17, further comprising the step of providing said identifier to said user on a magnetic strip card.

22. The method of claim 17, further comprising the step of providing said identifier to said user on an electronic multi-function card.

23. The method of claim 22, further comprising the step of providing said selected discount offer of interest to said user on said electronic multi-function card.

24. The method of claim 1, further comprising the steps of:
enabling said user to select one or more products and/or services that are of interest to said user only when a corresponding discount offer for said selected products and/or services becomes available;
storing said selected one or more products and/or services as a wish list in said user database;
comparing said selected one or more products and/or services with said data in said merchant database to identify wish list matches of said wish list of selected products and/or services and the currently available discount offers; and
listing said wish list matches in said personalized shopping guide to enable selection of one or more of said corresponding discount offers by said user.

25. The method of claim 1, wherein a user who provides said profile is a member, the method further comprising the steps of:
storing one or more advertisements corresponding to said discount offers received from said one or more merchants as data in an advertising database;
enabling a non-member to select a product of interest;
comparing said non-member selected product of interest with said data in said advertising database to identify advertising matches of said non-member selected product of interest and said advertisements; and
displaying said advertising matches to said non-member.
